(19) United States
(12) Patent Application Publication
(10) Pub. No.: US 2008/0247678 A1
(43) Pub. Date: Oct. 9, 2008

(54) Image processing apparatus

(75) Inventors: Yuji Okamoto, Kyoto (JP); Naofumi Ueda, Kyoto (JP)

Correspondence Address: Edwards Angell Palmer & Dodge LLP, P.O.Box 55874, Boston, MA, 02205, US

(73) Assignee: Sharp Kabushiki Kaisha, Osaka-shi (JP)

(21) Appl. No.: 12/078,994

(22) Filed: Apr. 9, 2008

(30) Foreign Application Priority Data
Apr. 9, 2007 (JP) 2007-101800
Apr. 9, 2007 (JP) 2007-101805

(51) Int. Cl. G06K 9/54

(52) U.S. Cl. 382/306

(57) ABSTRACT

An image scanning section 2 scans an information medium and inputs an image. An identification section 64 calculates a size of the information medium from the inputted image and identifies a type of the information medium. Alternatively, a reading section 8 reads identification information from an IC tag of the information medium. The identification section 64 identifies the type of the information medium based on the identification information. A position of a unique image representing personal information has been determined depending on the information medium. An area determination section 63 determines the unique image with respect to the information medium, and determines a position of a specific area in which the unique image exists in the inputted image. When a control section 7 confirms that a copy instruction has been given from an administrator, the control section 7 sets the specific area to be masked depending on a security level of the unique image. The control section 7 performs image processing for masking the set specific area. An image forming section 3 prints the image in a state where the unique image has been hidden.

### BACKGROUND OF THE INVENTION

1. Field of the Invention

The present invention relates to an image processing apparatus having a protection function with respect to copy of an information medium such as a credit card or a driver's license in which personal information has been described.

2. Description of the Related Art

In an information medium such as a credit card, a driver's license, an insurance certificate or a passport, personal information such as a card number, a facial photograph and a name of an identical person has been described. Such an information medium is also used for identification of a person. For example, the information medium is copied and a unique image representing the personal information is printed on a recording sheet. This recording sheet is used for the identification of the identical person.

The unique image is directly recorded on the recording sheet on which the information medium has been copied. Therefore, if a third party obtains this recording sheet, the personal information may be leaked and the personal information may be misused.

Japanese Patent Laid-Open No. 2001-231619 describes a holder in which the personal information described in the information medium can be masked. When the information medium put in the holder is copied, the image is printed with the unique image in a predetermined position hidden.

On the other hand, an image processing apparatus for copying an information medium restricts copying of a document by judging whether or not the document is copy restricted, as disclosed in Japanese Patent Laid-Open No. 2004-245962. In this case, the copy-restricted document is a special document on which an image is printed with magnetic inks or a document on which a resonant circuit is formed.

However, the above described image processing apparatus cannot identify the information medium such as a credit card as a copy-restricted document. Therefore, a unique image read from the surface of the information medium is copied directly. In other words, the image processing apparatus does not have a protection function for preventing the leakage of the personal information when the information medium is copied. In order to prevent the personal information from being unnecessarily copied, it is necessary to use the holder as described above, and the usage of the holder is cumbersome to users.

On the other hand, in the case of a user, such as an administrator having an authority capable of outputting images without restriction, when the administrator copies the information medium, the unique image in the information medium is copied without restriction. However, with respect to the recording sheet on which the copy has been performed, the personal information may be leaked depending on usage thereof.

In view of the above description, an object of the present invention is to provide an image processing apparatus capable of preventing personal information from leaking by inhibiting a unique image indicating personal information from being printed when the information medium is copied by users including the administrator.

### SUMMARY OF THE INVENTION

The present invention comprises an input section for inputting an image having a unique image from an information medium, an area determination section for determining a specific area in which the unique image exists, based on a type of the information medium, and a control section for performing image processing for selectively masking the specific area.

The unique image in the information medium is an image representing confidential information such as personal information. When processing such as copying is performed on the specific area in which this unique image exists without any restriction, the unique image is outputted and the confidential information is leaked. Consequently, it is possible to output an image in which some of unique images are hidden, by selectively masking the specific area. Thereby, important confidential information does not appear on the outputted image, and the confidential information is not leaked.

Even if the output of the image is permitted without restriction, the control section sets a range of the specific area to be masked and outputs an image in which the set specific area has been masked. In other words, an administrator has an authority for outputting the image without restriction. When the administrator instructs output of the image of the information medium, the control section selectively masks the specific area. Even when operating by the administrator, the output of the image is restricted since the specific area is masked. Thereby, security with respect to the outputted image can be improved.

Furthermore, the present invention comprises an identification section for identifying the type of the information medium, and the area determination section determines the specific area based on the type of the information medium. The specific area has been decided depending on the type of the information medium. Therefore, when the type of the information medium is identified, the area determination section can determine the specific area and determines the position of the specific area in the inputted image. The control section masks the specific area in the inputted image.

The identification section obtains information on a size of the information medium, and identifies the type of the information medium. The size is different depending on the type of the information medium. Consequently, the identification section obtains the information on the size by detecting the size of the information medium from the inputted image. Alternatively, the size is directly inputted, and thereby the identification section obtains the information on the size.

Alternatively, a reading section for communicating with a storage section provided in the information medium and reading identification information from the storage section is provided, and the area determination section determines the specific area in which the unique image exists, based on the identification information.

The identification information includes information on the information medium such as the type of the information medium. The area determination section can decide the specific area by obtaining this identification information. Then, the unique image representing the confidential information is hidden by masking the specific area. In other words, when the processing such as the copy has been performed with respect to the unique image in the information medium, the image is outputted in a state where the unique image has been hidden. Thereby, the personal information does not appear on the outputted image, and the personal information is not leaked.

The present invention comprises an identification section for identifying the type of the information medium based on the identification information, and the area determination section determines the specific area based on the type of the information medium. The specific area has been decided depending on the type of the information medium. Therefore, when the type of the information medium is identified, the area determination section can determine the specific area.

Here, the storage section in the information medium consists of an IC tag, and the reading section communicates with the IC tag in a noncontact manner and receives the identification information. Since the reading section performs the communication in the noncontact manner, the reading section can communicate with the IC tag to read the identification information at the same time as the image of the information medium is inputted.

The identification information includes information on a position of the specific area, and the area determination section determines a position at which the specific area exists in the inputted image based on the position information. Since the information on the position of the specific area is obtained from the identification information, it is possible to easily determine the position at which the specific area exists in the inputted image.

The present invention comprises a display section for displaying the specific area, the specific area displayed on the display section can be modified, and the control section masks the modified specific area. The display section displays the inputted image. This image also contains a unique image. The specific area determined by the area determination section may be not lined up from a position of the inputted unique image. In this case, modification such as a move and zoom in/out are performed with respect to the displayed specific area so that the unique image can be certainly hidden.

The area determination section determines the specific area to be masked depending on the security level. Based on this determination, the control section masks specific areas corresponding to all unique images in the information medium, or masks only specific areas corresponding to some unique images. The higher the security level is, the more the specific areas are masked, and prevention of the leakage of the personal information is strictly performed. When the security level is low, only some specific areas are masked, which permits disclosure of unimportant personal information.

The security level can be modified after the image has been inputted. When the security level is modified, the area determination section modifies the specific area to be masked. Depending on the purpose of using the personal information described in the information medium, it becomes necessary to modify the security level. Since the security level can be modified in this way, it is possible to obtain only necessary personal information.

The security level of the unique image is set depending on the type of the information medium, and the area determination section determines the specific area depending on the security level of the unique image. The personal information described in the information medium has a different importance degree depending on the type of the information medium. Consequently, the security level is previously set for each unique image. The area determination section determines a specific area to be masked and a specific area not required to be masked, based on the security level of the unique image.

The present invention includes an authentication section for authenticating a user, and the security level is set depending on the user. The security level of the user like the administrator having an authority is set to high. When the user is a user other than the administrator, the area determination section determines the specific area based on the security level of the security level of the user or the security level of the unique image, whichever is higher. If the user is not the administrator, the area determination section determines the specific area to be masked depending on the security level of the user. In the case of the user with a high security level, few specific areas are masked. In the case of the user with a low security level, many specific areas are masked, thereby preventing the personal information from leaking.

In consideration of the security level of the user and the security level of the unique image, the specific area can be strictly determined. The area determination section determines the specific area based on the higher security level of the security level of the user or the security level of the unique image, whichever is higher. Thereby, a unique image corresponding to the necessary personal information is not hidden and a unique image corresponding to unnecessary personal information is hidden, which can prevent the personal information from being unnecessarily leaked.

When image processing for masking the specific area is performed, the control section prohibits creation of log information related to this processing. Moreover, when image processing for masking the specific area is performed, the control section prohibits storage of the inputted image having the unique image. When this image processing is performed, the image containing the unique image is inputted. When log information is created, the inputted unique image may be stored as log information. Moreover, in a filing of storing images, all the inputted images are stored. In this way, the storage of the unique image may lead to the leakage of the personal information. Consequently, the creation of log information and filing are prevented, thereby preventing personal information from leaking.

Here, the information medium includes a driver's license, a card or the like which has an image representing the personal information as a unique image on its front side surface. The input section reads the front side surface of the information medium and inputs the image. Moreover, when the information medium has images on its front side surface and its back side surface, the input section reads the both sides of the information medium and inputs the images. Then, the control section synthesizes the images on both sides and outputs the two images side by side.

According to the present invention, when an image containing the personal information described in the information medium is outputted by copying the information medium or the like according to the instruction from the user such as the administrator, the specific area containing the unique image is masked and the image is outputted. Thereby, since the image is outputted in a state where the unique image is hidden, the confidential information such as the personal information is invisible. It is possible to prevent the leakage of the important confidential information regardless of how to use the outputted image, by selectively masking the specific area including the important confidential information.

Moreover, it is possible to precisely identify the specific area without being affected by poor reading at the time of inputting the image and the like, by using the identification information held in the information medium. Thereby, the unique image can be certainly hidden.

### BRIEF DESCRIPTION OF THE DRAWINGS

FIG. 1 is a control block diagram of an image processing apparatus of the present invention;

FIG. 2 is a diagram showing a schematic overall configuration of the image processing apparatus;

FIG. 3 is a diagram showing a front side surface and a back side surface of a credit card;

FIG. 4 is a diagram showing a front side surface and a back side surface of a cash card;

FIG. 5 is a diagram showing a front side surface and a back side surface of an insurance certificate card;

FIG. 6 is a diagram showing a front side surface of an insurance certificate;

FIG. 7 is a diagram showing an outputted image in which personal information in the credit card is hidden;

FIG. 8 is a flowchart showing a procedure of a card shot function;

FIG. 9 is a control block diagram of the image processing apparatus of another embodiment;

FIG. 10 is a diagram showing the front side surface and the back side surface of the credit card;

FIG. 11 is a diagram showing the front side surface and the back side surface of the cash card;

FIG. 12 is a diagram showing the front side surface and the back side surface of the insurance certificate card;

FIG. 13 is a diagram showing the front side surface of the insurance certificate;

FIG. 14 is a flowchart showing the procedure of the card shot function;

FIG. 15 is a diagram showing a setting screen for modifying a specific area;

FIG. 16 is a diagram showing a setting screen for modifying a security level; and

FIG. 17 is a flowchart showing a procedure at the time of executing the card shot function according to an instruction from an administrator.

### DETAILED DESCRIPTION OF THE PREFERRED EMBODIMENTS

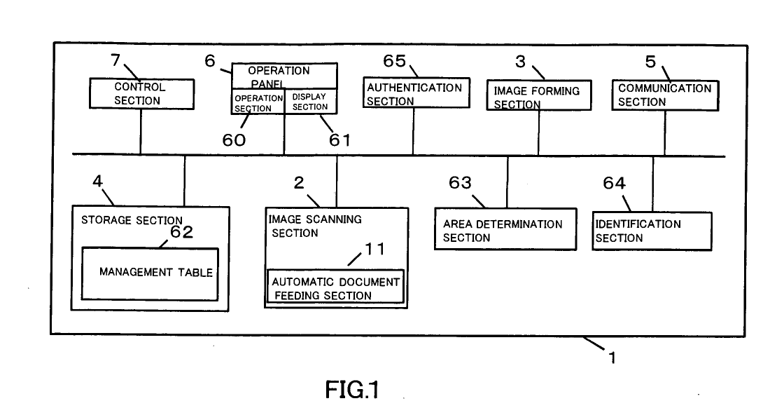

FIG. 1 shows an image processing apparatus of this embodiment. This image processing apparatus is a complex machine for performing a copy mode, a print mode, a scanner mode and a facsimile mode. A cabinet 1 of the image processing apparatus includes an image scanning section 2 for scanning a document and inputting image data, an image forming section 3 for processing and printing the image data, a storage section 4 for storing the image data, a communication section 5 for communicating with an external apparatus, an operation panel 6 for input operations, and a control section 7 for controlling processing sections to execute processing of the image data depending on the mode. It should be noted that the processing sections, which performs processing to output the inputted image data, in configured to include the image forming section 3, the storage section 4 and the communication section 5.

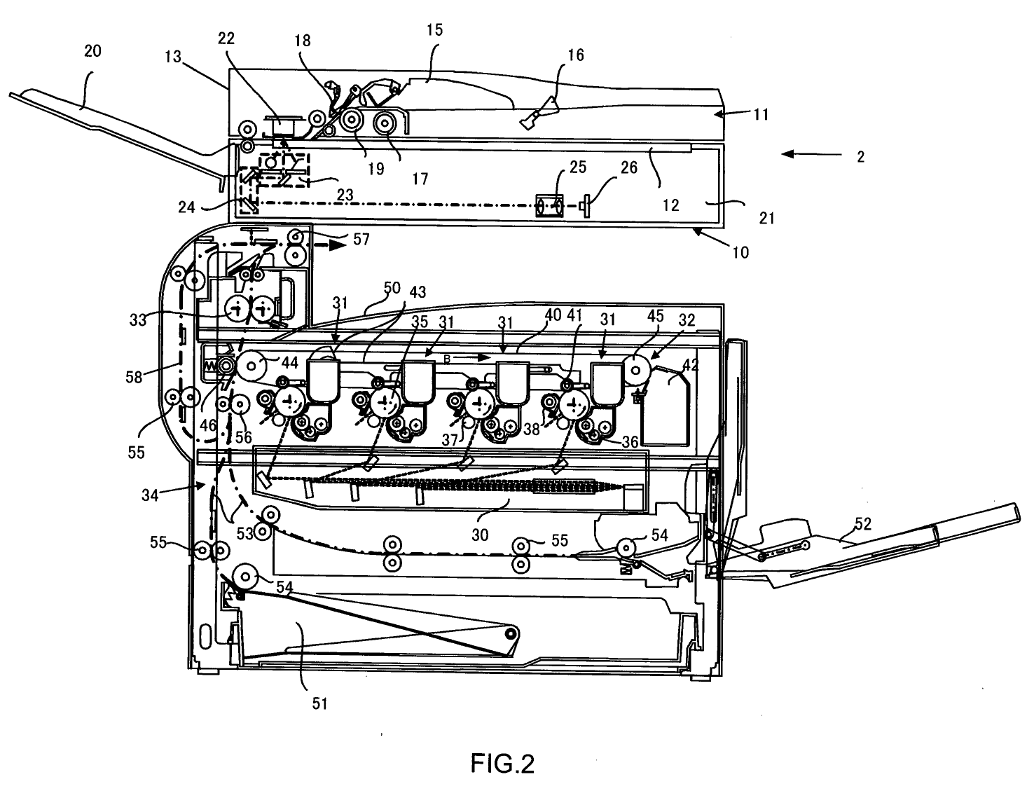

As shown in FIG. 2, the image scanning section 2 is placed above the cabinet 1, and includes a scanner section 10 and an automatic document feeding section 11. The automatic document conveying section 11 is positioned above the scanner section 10, and automatically feeds a document for reading the image data of the document.

On the upper surface of the cabinet 1, a document table 12 made of a platen glass is provided, and a document cover 13 for covering the document table 12 is provided. The automatic document feeding section 11 is mounted integrally with the document cover 13. The document cover 13 can be freely opened and closed, and when the document cover 13 is in a closed state, the document is fed by the automatic document feeding section 11. When the document cover 13 is in an opened state, the document can be placed on the document table 12. Opening and closing of the document cover 13 are detected by a cover opening and closing sensor. Moreover, a document size detection sensor for detecting a size of the document placed on the document table 12 is provided.

When the document is set on a document setting tray 15 in the automatic document feeding section 11, a document detection sensor 16 detects that the document is placed. Then, at the operation panel 6, copy conditions such as a size of a recording sheet on which printing is performed and a variable magnification are inputted. Subsequently, with the input operation on a start key, the reading of an image of the document is started.

In the automatic document feeding section 11, each document on the document setting tray 15 is drawn one by one by a pickup roller 17. The document is sent through between a stacking plate 18 and a conveyer roller 19 to the document table 12. The document is conveyed in a vertical scanning direction on the document table 12 and ejected onto a document ejection tray 20. The document ejection tray 20 is provided with a document ejection sensor, which detects whether there is the document on the document ejection tray 20.

The scanner section 10 is provided with a first scanning section 21 and a second scanning section 22. A scanning area is formed at one side of the document table 12. When the document is fed onto the document table 12, the document passes through the scanning area. A first scanning unit 23 of the first scanning section 21 is located below the scanning area, and the front side surface (lower side surface) of the document is scanned.

When the document is fed onto the document table 12 by the automatic document feeding section 11, the first scanning unit 23 is moved to a scanning position to be positioned therein, and a second scanning unit 24 is also positioned at a predetermined position. The front side surface of the document is irradiated from the lower side of the document table 12 by an exposure lamp of the first scanning unit 23. Reflected light from the document is guided to an imaging lens 25 by respective reflecting mirrors in the first and second scanning units 23 and 24. The reflected light of the document is collected to a CCD 26 by the imaging lens 25. An image on the front side surface of the document is formed on the CCD 26. Thereby, the image of the front side surface of the fed document is scanned.

Moreover, a back side surface (upper side surface) of the document is scanned by the second scanning section 22. The second scanning section 22, which is placed above the document table 12, includes an LED for irradiating the back side surface of the document, an exposure lamp array having a fluorescent light or the like, a SELFOC lens array for collecting the reflected light of the document for each pixel, a Contact Image Sensor (CIS) which photoelectrically converts the reflected light from the document received through the SELFOC lens array and outputs an analog image signal, and the like. Thereby, an image of the back side surface of the fed document is scanned.

When a document is placed on the document table 12, the image of the front side surface of the document is scanned by the first scanning section 21. The first and second scanning units 23 and 24 move in the vertical scanning direction while mutually maintaining a predetermined velocity relationship. The document on the document table 12 is exposed by the first scanning unit 23, and the reflected light from the document is guided to the imaging lens 25 by the first and second scanning units 23 and 24. The image of the document is formed on the CCD 26 by the imaging lens 25.

In this way, when a single side or both sides of the image of the document is scanned, the single side or the both sides of the document are inputted to the control section 7. The control section 7 has an image processing section, which performs various kinds of image processing on the image data. This image data is outputted to the image forming section 3.

On the basis of the inputted image data, the image forming section 3 prints a color image or a monochrome image on a recording sheet. The image forming section 3 includes a laser scanning unit 30, four image stations 31, an intermediate transfer belt unit 32, a fixing apparatus 33 and a carrying apparatus 34.

Each image station 31 forms a color images according to each of the colors: black, cyan, magenta and yellow. Each image station 31 includes a photoreceptor drum 35, a developing apparatus 36, a charging apparatus 37, a cleaning apparatus 38 and a neutralization apparatus (not shown).

The photoreceptor drum 35 is rotatably driven in one direction. The cleaning apparatus 38 cleans residual toner on a surface of the photoreceptor drum 35. The neutralization apparatus performs neutralization with respect to the surface of the photoreceptor drum 35. The charging apparatus 37 uniformly charges the surface of the photoreceptor drum 35.

The laser scanning unit 30 modulates laser light based on the image data inputted from the image scanning section or the like, repetitively scans the surface of the photoreceptor drum 35 in a horizontal scanning direction with this laser light, and forms an electrostatic latent image on the surface of the photoreceptor drum 35. The developing apparatus 36 supplies toner to the surface of the photoreceptor drum 35, develops the electrostatic latent image, and forms a toner image on the surface of the photoreceptor drum 35.

The intermediate transfer belt unit 32 includes an intermediate transfer belt 40, an intermediate transfer roller 41, a transfer belt cleaning apparatus 42 and a tension mechanism 43. The intermediate transfer belt 40 is placed above each photoreceptor drum 35, hung and is wound around a driving roller 44 and a driven roller 45 so as to rotate in a direction of an arrow B.

The intermediate transfer roller 41 is placed to face the photoreceptor drum 35 with the intermediate. transfer belt 40 therebetween, and applied with a transfer bias voltage. A voltage of reverse polarity with respect to the toner is applied by the intermediate transfer roller 41, and thereby the toner image on the surface of the photoreceptor drum 35 is transferred to the intermediate transfer belt 40. The toner image of each color is layered on the intermediate transfer belt 40, and a synthesized multicolor toner image is formed.

A transfer roller 46 is placed to be pressed against the intermediate transfer belt 40, and applied with the voltage of the reverse polarity with respect to the toner. The toner image on the intermediate transfer belt 40 is transferred on the recording sheet which has been conveyed between the transfer roller 46 and the intermediate transfer belt 40, by the transfer roller 46. Residual toner on the intermediate transfer belt 40 is cleaned by the transfer belt cleaning apparatus 42.

The toner image transferred on the recording sheet is heated and pressurized by the fixing apparatus 33 and fixed on the recording sheet, and the image is formed on the recording sheet. The recording sheet on which the image has been printed in this way is ejected to an ejection tray 50 provided on the upper portion of the cabinet 1.

The carrying apparatus 34 conveys the recording sheet from a sheet cassette 51 or a manual tray 52 along a carrying path 53. The carrying path 53 passes through between the intermediate transfer belt 40 and the transfer roller 46, and then through the fixing apparatus 33, and reaches the ejection tray 50.

The carrying apparatus 34 includes a pickup roller 54, a feeding roller 55, a resist roller 56 and an ejection roller 57. A recording sheet on the sheet cassette 51 or the manual tray 52 is sent to the carrying path 53 one by one, conveyed along the carrying path 53 and ejected to the ejection tray 50. While this recording sheet is being conveyed, the image is printed on the recording sheet. Moreover, a switchback carrying path 58 is provided for double sided printing. The recording sheet on which the fixing has been performed is passed through the switchback conveying path 58 by the conveyer roller 55, and conveyed between the intermediate transfer belt 40 and the transfer roller 46. The recording sheet on which the double sided printing has been performed passes through the fixing apparatus 33 and is ejected to the ejection tray 50.

The operation panel 6 is provided in the scanner section 10 and includes an operation section 60 and a display section 61. The operation section 60 includes various operation keys. The display section 61 consists of a liquid crystal display, and is configured as a touch panel. Touch keys are formed in an operation screen displayed on the display section 61, and these touch keys also function as the operation keys.

The communication section 5 includes a communication interface, and the communication interface is connected to a network such as a LAN or a WAN. Multiple external apparatuses are connected to the network. The examples of the external apparatuses include other image processing apparatuses, information processing apparatuses such as personal computers, and servers. The network is connected to the Internet from a router via a communication line such as a telephone line or an optical fiber. The communication section 5 can communicate with the external apparatuses through the network according to a predetermined communication protocol. Moreover, the image processing apparatuses can also communicate with each other. It should be noted that the communication within the network may be wired or wireless. An image processing system is formed with these image processing apparatuses and external apparatuses.

Moreover, the communication section 5 includes a modem apparatus. The telephone line is connected to the modem apparatus. The image processing apparatus can perform facsimile communication. It should be noted that image processing apparatus can also perform data communication via an Internet facsimile through the network. Furthermore, the communication section 5 includes a communication terminal or a communication card for wireless communication. A storage medium such as a USB memory or an IC card is connected to the communication terminal, and the communication section 5 transmits and receives data to and from the storage medium. Moreover, though the communication card, the communication section 5 transmits and receives the data to and from a communication terminal such as a mobile phone or a PDA via the wireless communication.

The storage section 4 consists of a hard disk apparatus. The storage section 4 stores the image data inputted from the image scanning section 2 or the image data inputted from the communication section 5. It should be noted that the inputted image data is temporarily stored in an image memory such as a DRAM, undergoes image processing and encryption processing, and subsequently is transferred from the image memory to the storage section 4. Moreover, when the image data is read from the storage section 4, the image data is applied with the image processing or a decryption processing, and stored in the image memory. Subsequently, the image data is outputted to the outside via the printing, the data transmission or the facsimile communication according to the processing to be performed.

The storage section 4 has a management table 62 which stores information required for operating the image processing apparatus, such as control information and setting information on the image processing apparatus and user authentication information. When such information is created or modified, the information in the management table 62 is updated. It should be noted that the management table 62 may be provided in a nonvolatile memory other than the storage section 4.

The control section 7 consists of a microcomputer having a CPU, a ROM and a RAM, and the CPU reads a control program stored in the ROM out to the RAM and executes the control program. According to the control program, each section operates. When the image data is inputted from the input section such as the image scanning section 2 or the communication section 5, any mode among the print mode, the copy mode, the scanner mode and the facsimile mode is executed on the basis of the processing conditions contained in information inputted from the operation section 60 or header information of the image data inputted from the external apparatus. Moreover, the control program includes a browser and mailing software, and the control section 7 performs the data communication or transmits and receives emails to and from external apparatus by a communication protocol such as a TCP/IP protocol.

When the control section 7 performs each mode, the control section 7 temporarily stores the inputted image data in the storage section 4. Moreover, the control section 7 executes a filing mode for storing the inputted image data in the storage section 4 and managing the image data. The stored image data is outputted again according to instructed processing.

The outputted image data is deleted from the storage section 4, according to an instruction from the control section 7. In this deletion, the image data is invalidated so that the image data cannot be restored, by overwriting random data on the image data. In this way, unauthorized use of the image data is prevented by performing invalidation processing and subsequent encryption processing.

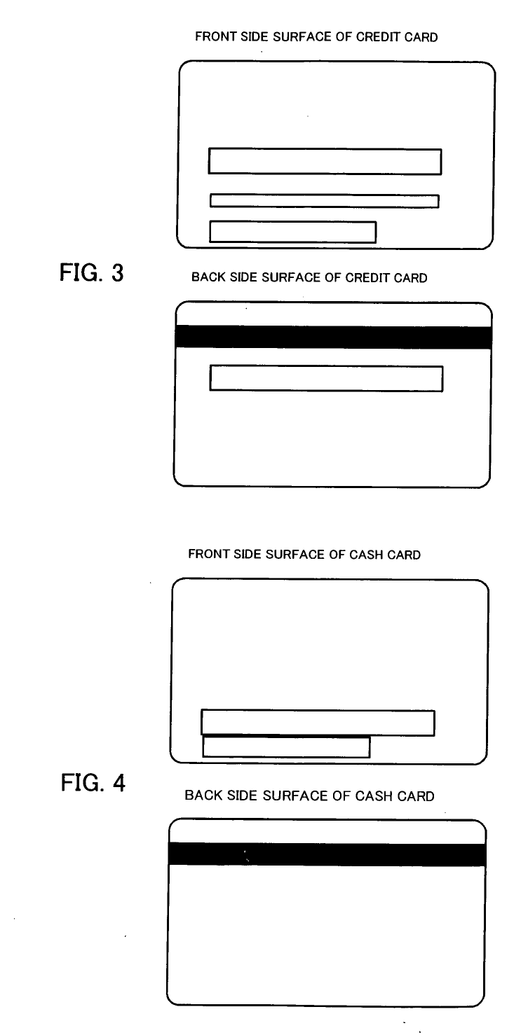

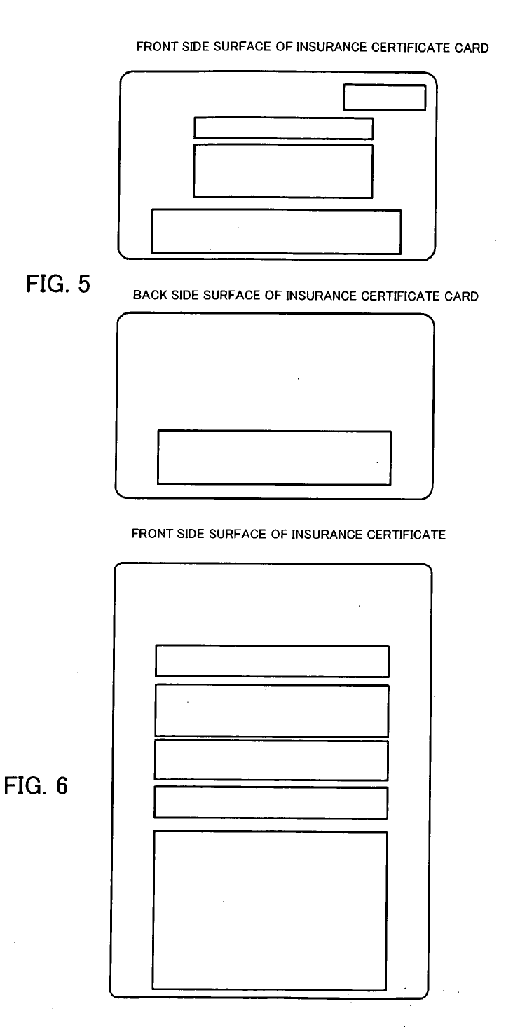

Here, personal information has been described in an information medium such as a credit card, a driver's license, an insurance certificate or a basic resident register card. For example, in the credit card, as shown in FIG. 3, a card number, an expiration date and a full name are described on its front side, and a signature is described on its back side. In a cash card, as shown in FIG. 4, a card number and a full name are described on its front side. In an insurance certificate card, as shown in FIG. 5, an expiration date, symbols, a full name, a birth date and the like are described, and an address is described on its back side. Also in the insurance certificate shown in FIG. 6, symbols, a full name, a birth date and the like are described on its front side. In a driver's license, a full name, a birth date, an address and a domicile of origin are described on its front side. In a passport, a full name, a birth date, an address and a facial photograph are described.

As described above, the unique image is formed as an image representing the personal information on the front side surface and further on the back side surface of various kinds of information media. A specific area in which the unique image exists is determined for each information medium. It should be noted that multiple unique images are formed in an information medium and there are multiple specific areas.

The image processing apparatus in accordance with the present invention has a protection function for preventing the personal information from being unnecessarily leaked when an image in the information medium is processed. In other words, as shown in FIG. 1, the image processing apparatus includes an area determination section 63 for determining a specific area and an identification section 64 for identifying a type of the information medium when an image containing a unique image is inputted from the information medium by the input section. Operations of the area determination section 63 and the identification section 64 are controlled by the control section 7. The control section 7 performs image processing of masking the specific area when performing image processing on the inputted image.

The identification section 64 obtains information on a size of the information medium and identifies the type of the information medium. The size of the information medium is identified by the type thereof. The management table 62 stores in advance information medium management information on the sizes of an information medium for each type thereof, the shape of the unique images and the positions of the specific areas. When the information medium is scanned by the image scanning section 2, the identification section 64 recognizes the circumference of the information medium from the inputted image, and calculates the size of the information medium. At this time, the control section 7 recognizes that the image of the information medium is inputted and executes the protection function. The identification section 64 refers to the information medium management information and identifies the type of the information medium based on the obtained size. Alternatively, a user inputs the size through the operation section 60. Thereby, the size of the information medium can also be obtained, and the identification section 64 identifies the type of the information medium based on the inputted size.

Here, for example, the credit card and the cash card are the same in size. As such, information media different in type may be the same in size. However, the unique images differ in shape and position for each information medium. Consequently, the identification determination section 64 extracts the unique image from the inputted image and recognizes its shape and position. Then, the identification section 64 identifies the type of the information medium by referring to the information medium management information.

The area determination section 63 determines the specific area based on the type of the information medium. The type of the information medium corresponds to the specific area thereof. The area determination section 63 identifies the specific area in the information medium by referring to the information medium management information. Here, based on the inputted image of the information medium, the position of the circumference is known. The specific area is positionally fixed relative to the circumference. Therefore, the area determination section 63 can determine the position of the specific area in the inputted image.

In the control section 7, the image processing section fills in the specific area with a solid image or overwrites the specific area with another image, and thereby the image processing for masking the specific area is performed.

The image data which underwent such image processing is outputted to the image forming section 3, and an image in which the unique image is hidden is printed and outputted to the outside. It should be noted that, instead of the printing, the image data may be outputted to the external apparatus via the data communication by outputting the image data to the communication section 5. In the external apparatus, the image in which the unique image has been hidden is displayed or printed.

Thus, when the image processing apparatus scans the information medium in which the unique image such as personal information is recorded, the image is outputted in a state where the unique image is unknown. Therefore, even if a third party tries to copy the information medium and bring out the personal information, the unique image related to the personal information is hiddenly outputted, thereby preventing the personal information from leaking.

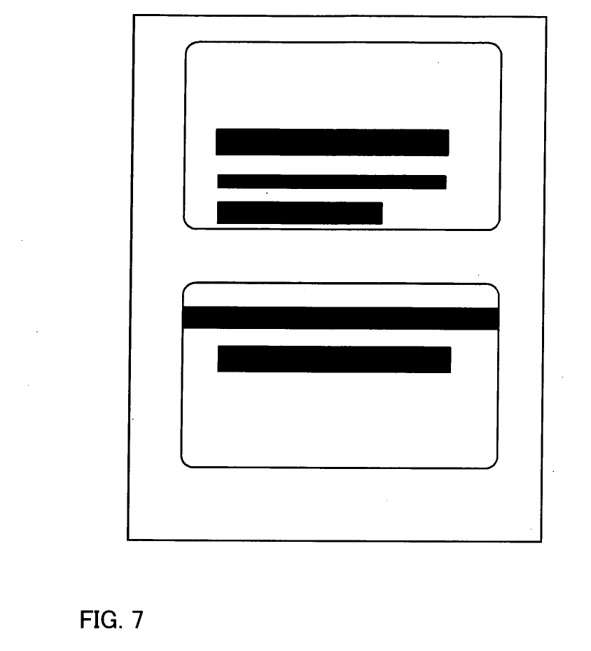

Moreover, the image processing apparatus has a function to scan the images from the front and back sides of the information medium, synthesize the respective images of the front and back sides, and output the images side by side onto one page. Here, this function is referred to as “card shot function”. When an instruction for the card shot function is performed, the control section 7 automatically executes the above described protection function. Thereby, two images in which the unique images are hidden are arranged in one page and outputted side by side as shown in FIG. 7. It should be noted that, in the case of the information medium containing the image only on a single side, when the card shot function is executed, the image of one side is outputted on one page.

Here, for the purpose of identification, related parties including an identical person may copy the information medium. In order to be able to deal with such a case, the area determination section 63 determines the specific area depending on a security level. Thereby, the determined specific area is masked. With a high security level, more specific areas are masked. With a low security level, few specific areas are masked.

The image processing apparatus is provided with an authentication section 65 for authenticating the user, and the security level is set depending on the user. When the authentication information such as ID information, a password and biological information is inputted, the authentication section 65 determines the user based on this information. Then, based on user information which has been previously registered, the authentication section 65 authenticates the user. The user information includes a security level determined for each user. The security level of the user like an administrator with a high authority is set to high, and the security level of the user with a low authority is set to low. The processing on the inputted image is controlled depending on whether this security level is high or low.

Moreover, the security level is also assigned to the unique image. The personal information described in the information medium includes information which cause a problem if the information is leaked, and information which will not cause a serious problem even if the information is leaked. The more important the personal information to which the unique image corresponds is, the higher the security level is set to. Consequently, the security level is determined for each unique image of the information medium, and the security level of each unique image is stored in advance in the information medium management information. Whether or not to mask is determined depending on whether this security level is high or low.

The area determination section 63 determines the specific area depending on the security level of the user and the security level of the unique image. In other words, the area determination section 63 compares the security level of the user with the security level of the unique image, and determines the specific area to be masked, based on the security level whichever higher. Thereby, when multiple unique images exist in the information medium, some unique images are selected depending on the security level, and the specific areas containing these unique images are determined as the specific areas to be masked. On the other hand, the specific areas corresponding to remaining unique images which were not selected are not masked.

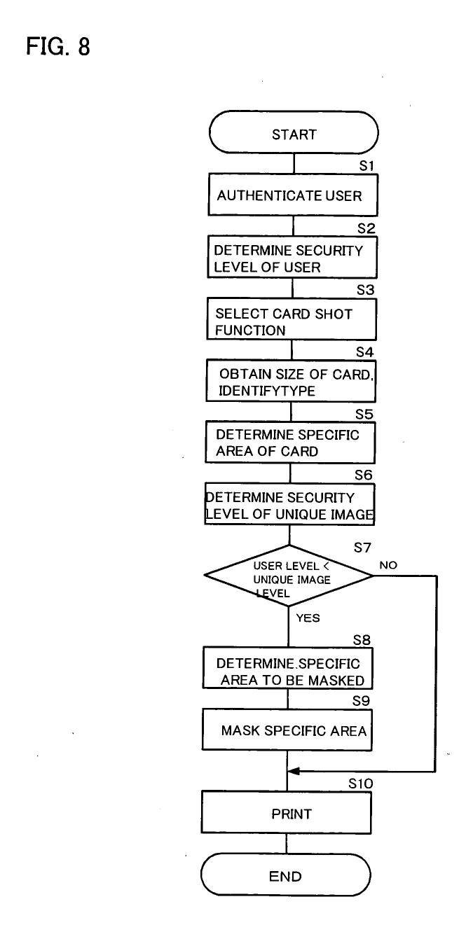

With reference to FIG. 8, the operation of performing the card shot function will be described. Here, it is assumed that the credit card is copied. First, the user operates the image processing apparatus to input the ID information and the authentication information. The authentication section 65 verifies this information and authenticates the user (S1). Then, based on the user information, the authentication section 65 determines the security level of the user (S2). If the user is not a registered user, the user is not authenticated and his usage of the image processing apparatus is regulated so that only limited operations are permitted.

The user places the credit card on the document table 12, and selects the card shot function through the operation section 60 (S3). With the operation on the start key, the image scanning section 2 scans the front side surface of the credit card. The user reverses the credit card and places the credit card on the document table 12. With the operation on the start key, the image scanning section 2 scans the back side surface of the credit card.

The identification section 64 calculates the size of the read credit card based on the inputted image. With reference to the information medium management information, the identification section 64 identifies the type of the information medium corresponding to this size (S4). Thereby, the information medium is identified as the credit card.

When it is determined that the information medium is the credit card, the area determination section 63 verifies the position of the specific area within the credit card based on the information medium management information, assigns the position to the inputted image, and determines the specific area (S5).

The area determination section 63 scans the security level of the user from the user information (S6). Moreover, the area determination section 63 also scans the security level of the unique image from the information medium management information. Then, the area determination section 63 compares the both security levels (S7).

When the security level of the user is higher than the security level of the unique image, the processing depending on the security level of the user is performed. In other words, since the user is a person like the administrator having an authority if the security level of the user is higher, the control section 7 does not mask the specific area and outputs the image to the image forming section 3. Thereby, the inputted image is directly printed (S10).

When the security level of the unique image is higher than the security level of the user, the area determination section 63 decides the specific area to be masked (S8). Then, the control section 7 performs the image processing for masking the specific area (S9), and the image forming section 3 prints the image(S10).

Here, the specific areas are determined so that the specific areas covering all the unique images in one credit card are masked. Instead of this, the area determination section 63 can also determine whether or not to mask each of individual unique images, and determine the specific area.

The area determination section 63 compares the security level of each unique image with the security level of the user, and determines the specific area to be masked and the specific area not to be masked. In response to this determination, the control section 7 masks some specific areas and does not mask the remaining specific areas. For example, a specific area corresponding to a unique image representing the card number is masked, and a specific area corresponding to a unique image representing the expiration date is not masked. Alternatively, a specific area corresponding to the last four digits of the card number is masked, and a specific area corresponding to other digits of the card number is not masked. Moreover, even if the security level of the unique image is the same, the specific area to be masked is different depending on the user. In the case of the user with the high security level, a specific area corresponding to the name is masked. However, in the case of the user with the low security level, the specific area corresponding to the card number is masked, in addition to the name.

In this way, since the specific area corresponding to each unique image is individually masked depending on the security level, the image is outputted in a state where some of the unique images are hidden. Therefore, it is possible to provide the personal information required for the identification and the like while unnecessary personal information is kept in secrecy, and thereby it is possible to prevent the personal information from being unnecessarily leaked.

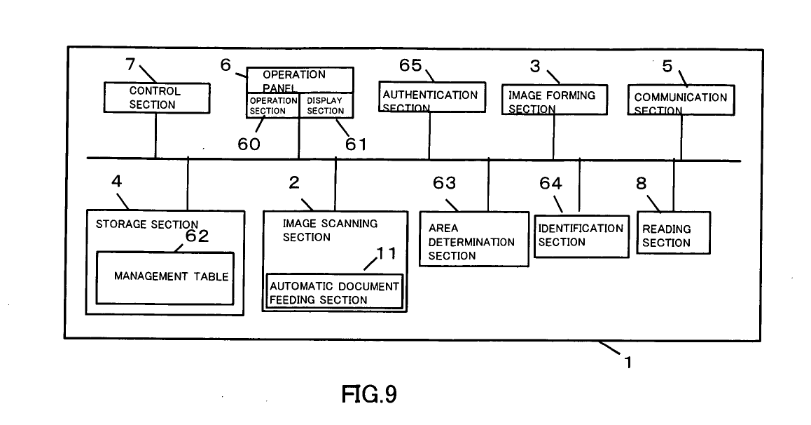

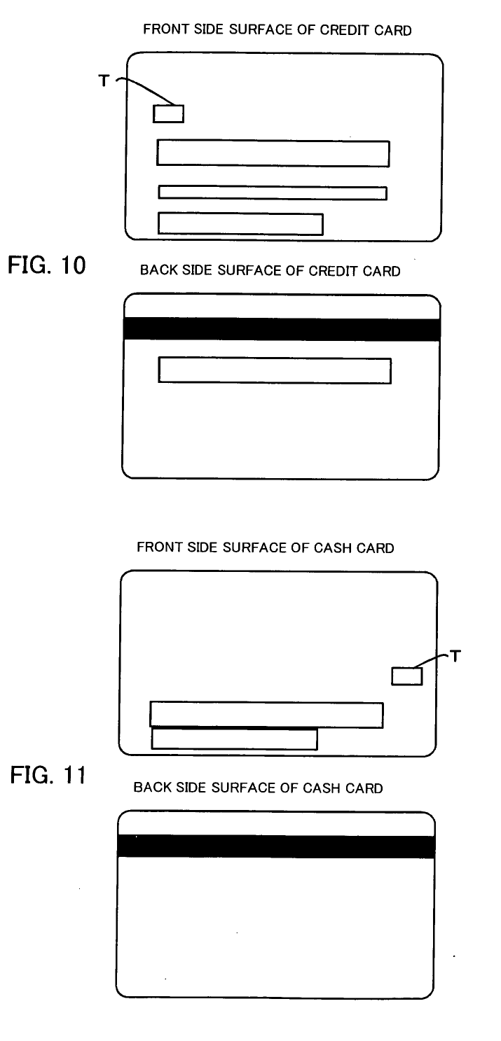

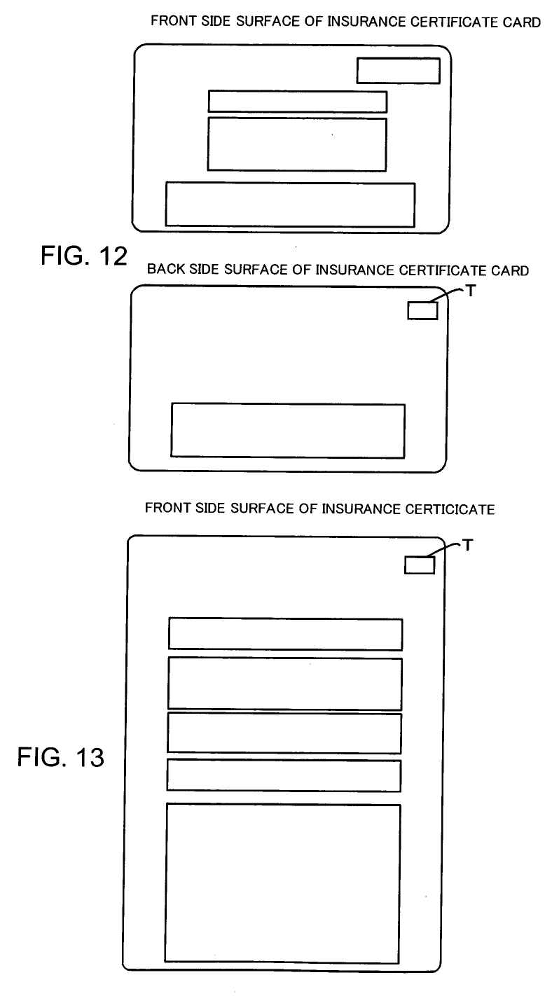

FIG. 9 shows the image processing apparatus of another embodiment. The image processing apparatus includes a reading section 8 for communicating with an IC tag T. Other configurations are the same as the above described image processing apparatus. As shown in FIGS. 10 to 13, the information medium such as the credit card, the cash card, the insurance certificate card, the insurance certificate, the driver's license or the basic resident register card has the IC tag T. The IC tag T is embedded in or attached to the information medium. Identification information on the information medium has been stored in a storage section of the IC tag T. This identification information shows the type of the information medium.

The identification section 64 of this image processing apparatus obtains the identification information on the information medium through the reading section 8, and identifies the type of the information medium. The size of the information medium has been prescribed depending on its type. In the management table 62, the information medium management information on the sizes of the various information media, the forms of the unique images and the positions of the specific areas, has been stored in advance. When the information medium has been scanned by the image scanning section 2, the determination section 64 recognizes the circumference of the information medium from the inputted image, and calculates the size of the information medium. At this time, the control section 7 recognizes that the image of the information medium has been inputted and causes the reading section 8 to operate. The reading section 8 communicates with the IC tag T in the information medium and outputs the read identification information to the determination section 64. It should be noted that the reading section 8 may constantly or intermittently emit radio waves and constantly keep the IC tag T in a communicable state.

The control section 7 executes the protection function in response to the input of the image of the information medium. The identification section 64 identifies the type of the information medium based on the obtained identification information, with reference to the information media management information. Moreover, the identification section 64 extracts the unique image from the inputted image and recognizes its form and the position of the unique image on the inputted image.

The area determination section 63 determines the specific area based on the type of the information medium. In other words, the area determination section 63 determines the specific area in the determined information medium with reference to the information media management information. Here, based on the inputted image of the information medium, the position of the circumference can be known. The specific area exists at the fixed position with respect to this circumference. Therefore, the area determination section 63 can determine the position of the specific area in the inputted image.

In the control section 7, the image processing section fills in the specific area with the solid image or overwrites the specific area with another image, and thereby the image processing for masking the specific area is performed.

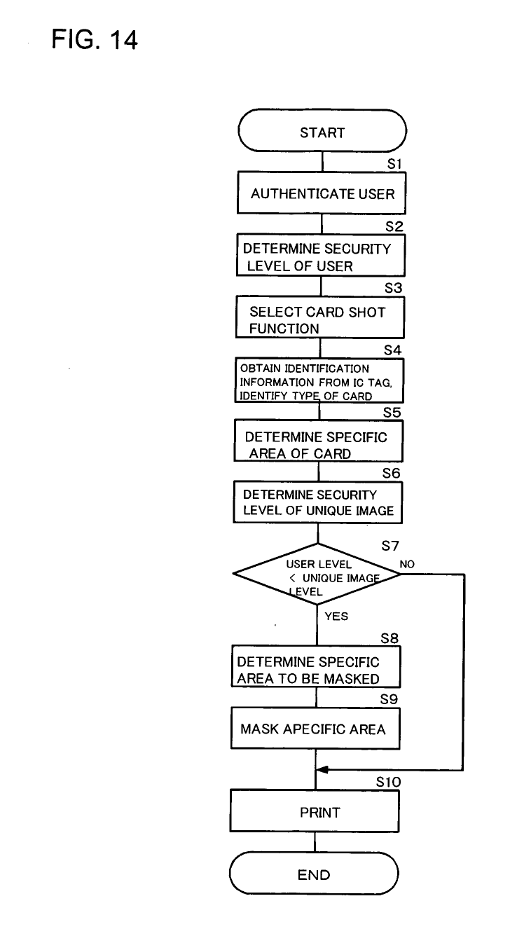

FIG. 14 shows the procedure at the time of executing the card shot function when copying the credit card. It should be noted that the same operations as those shown in FIG. 8 are attached with the same step numbers. First, the user operates the image processing apparatus to input the ID information and the authentication information. The authentication section 65 verifies this information and authenticates the user (S1). Then, based on the user information, the authentication section 65 identifies the security level of the user (S2). If the user is not the registered user, the user is not authenticated and his usage of the image processing apparatus is regulated so that only limited operations are permitted.

The user places the credit card on the document table 12, and selects the card shot function through the operation section 60 (S3). With the operation on the start key, the image scanning section 2 scans the front side surface of the credit card. The user reverses the credit card and places the credit card on the document table 12. With the operation on the start key, the image scanning section 2 scans the back side surface of the credit card.

The reading section 8 communicates with the IC tag T and receives the identification information. The identification section 64 identifies the type of the information medium based on the identification information (S4). Thereby, the information medium is identified as the credit card.

When it is determined that the information medium is the credit card, the area determination section 63 verifies the position of the specific area within the credit card based on the information medium management information, assigns the position with respect to the inputted image, and identifies the specific area (S5).

The area determination section 63 reads the security level of the user from the user information (S6). Moreover, the area determination section 63 also reads the security level of the unique image from the information medium management information. Then, the area determination section 63 compares the both security levels (S7).

When the security level of the user is higher than the security level of the unique image, the processing depending on the security level of the user is performed. In other words, since the user is the person like the administrator having the authority if the security level of the user is higher, the control section 7 does not mask the specific area and outputs the image to the image forming section 3. Thereby, the inputted image is directly printed (S10).

When the security level of the unique image is higher than the security level of the user, the area determination section 63 determines the specific area to be masked (S8). Then, the control section 7 performs the image processing for masking the specific area (S9), and the image forming section 3 prints the image (S10).

Here, the specific areas are determined so that the specific areas corresponding to all unique images in one credit card are masked. Instead, the area determination section 63 can also determine whether or not to mask each of individual unique images, and determines the specific area.

The area determination section 63 compares the security level of each unique image with the security level of the user, and determines the specific area to be masked and the specific area not to be masked. In response to this decision, the control section 7 masks some specific areas and does not mask the remaining specific areas. For example, the specific area corresponding to the unique image representing the card number is masked, and the specific area corresponding to the unique image representing the expiration date is not masked. Alternatively, the specific area corresponding to the last four digits of the card number is masked, and the specific area corresponding to the other digits of the card number is not masked. Moreover, even if the security level of the unique image is the same, the specific area to be masked is different depending on the user. In the case of the user with the high security level, the specific area corresponding to the name is masked. However, in the case of the user with the low security level, the specific area corresponding to the card number is masked, in addition to the name.

In this way, since the specific area corresponding to each unique image is individually masked depending on the security level, the image is outputted in the state where some of the unique images have been hidden. Therefore, it is possible to provide the personal information required for the identification and the like while the unnecessary personal information is kept in secrecy, and thereby it is possible to prevent the personal information from being unnecessarily leaked.

Incidentally, even the information medium of the same type may have, for example, different number of digits in the card number, or a longer name or address. In such a case, a specific area corresponding to an actual unique image may become larger with respect to the specific area which has been previously prescribed. Consequently, the area determination section 63 can modify the specific area.

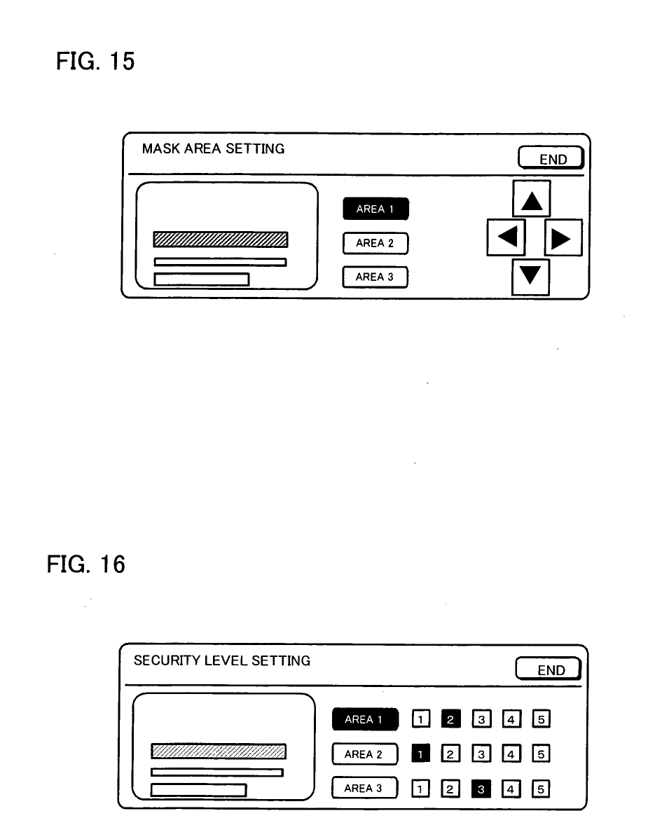

When the specific area in the inputted image is determined, an area setting screen is displayed on the display section 61, as shown in FIG. 15. In this screen, the unique image and the specific area are displayed, and modification keys are also displayed. Each specific area can be moved, enlarged and reduced on the display section 61. When one specific area is selected, this specific area is moved, enlarged or reduced with operations on the modification keys. However, the modification of the specific area is limited. A movement amount, an enlargement ratio and a reduction ratio are limited within respective decided ranges. Since a modification amount is limited in this way, it is possible to prevent the unique image within the specific area from being out of the modified specific area.

When the modification of the specific area is completed, the area determination section 63 updates information on the position of the specific area in the inputted image. The control section 7 performs the image processing for masking the modified specific area. Therefore, it is possible to certainly hide the unique image by modifying the specific area so as to fit the unique image, and thereby it is possible to prevent the leakage of the personal information.

Moreover, the security level of the unique image can be modified. The security level has been previously set with respect to each unique image in the information medium. However, in response to a request from the user, there is a case where it is necessary to hide the unique image or expose the unique image.

Consequently, after the image has been inputted, the control section 7 modifies the security level of the unique image according to an instruction from the user. A security level setting screen is displayed on the display section 61, as shown in FIG. 16. In this screen, the unique image and the specific area are displayed, and security level keys are also displayed. Multiple security level keys correspond to each specific area. The user selects one specific area and selects an arbitrary security level. The control section 7 temporarily modifies the security level of the unique image corresponding to the specific area. The area determination section 63 determines whether or not to mask the specific area, based on the modified security level of the unique image and the security level of the user.

A specific area which is not normally masked is masked by setting the security level of the unique image to high. Conversely, a specific area which is normally masked is not masked by setting the security level of the unique image to low. Therefore, the unique image can be hidden as appropriate and it is possible to prevent the leakage of the unnecessary personal information.

It should be noted that the modification of the security level may be limited to the user having the security level which is equal to or more than a certain security level. For example, the modification is limited to the user having the security level which is equal to or more than the security level of the unique image. If all users can modify the security level, it becomes possible to copy the information medium of the third party without hiding the unique image therein, which causes a security problem. Consequently, the limitation of the modification can eliminate such a problem. Moreover, although the security level is temporarily modified in the above description, normal modification corresponds to modification of settings and is performed by the user having the authority. Based on this modification, the information medium management information is updated.

In the image processing apparatus, when processing has been performed with respect to the inputted image, the control section 7 creates log information with respect to the processing and stores the log information in the storage section 4. This log information is attached with the inputted image, and the image data of the unique image is stored therein. However, from a viewpoint of protection of the personal information, the control section 7 prohibits the creation of the log information when the card shot function has been executed.

Thereby, when the image of the information medium is processed, the log information is not created. Moreover, the inputted image data of the information medium is deleted from the storage section 4 or the memory after the processing is completed. Therefore, the image data of the unique image is not left in the image processing apparatus. Accordingly, the personal information described in the information medium is not leaked from the image processing apparatus.

Moreover, when the card shot function has been executed, the control section 7 prohibits the execution of the filing mode for storing the inputted image data in the storage section 4. Also thereby, the image data of the unique image is not stored, and it is possible to prevent the personal information from being leaked from the image processing apparatus.

Incidentally, the administrator has an authority capable of performing the processing with respect to the inputted image without restriction. In this image processing apparatus, when the image of the information medium is processed, if there is an instruction for processing from the administrator, the output of the unique image is restricted.

The control section 7 sets a range of the specific area to be masked, and selectively masks the set specific area. At this time, the control section 7 sets the range to be masked depending on the security level of the unique image. If the security level of the unique image is high, the specific area in which this unique image exists is masked. If the security level of the unique image is low, the specific area in which this unique image exists is not masked. Whether or not to mask is determined depending on whether or not the security level is equal to or more than a predetermined level.

It should be noted that the range to be masked may not be the entire specific area, and may be a part of the specific area. The range to be masked within the specific area can be modified depending on the security level of the unique image.

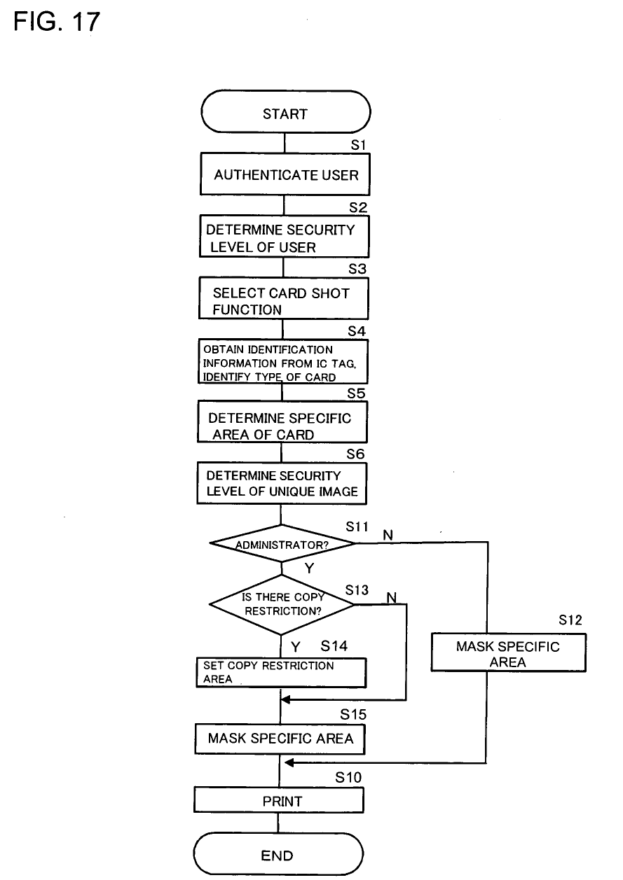

Operations of the image processing apparatus in the case where the administrator copies the information medium will be described according to FIG. 17. It should be noted that the same operations as those shown in FIG. 8 are attached with the same step numbers. First, the user operates the image processing apparatus to input the ID information and the authentication information. The authentication section 65 verifies this information and authenticates the user (S1). Then, based on the user information, the authentication section 65 identifies the security level of the user (S2).

The user places the credit card on the document table 12, and selects the card shot function through the operation section 60 (S3). With the operation on the start key, the image scanning section 2 scans the front side of the credit card. The user reverses the credit card and places the credit card on the document table 12. With the operation on the start key, the image scanning section 2 scans the back side surface of the credit card.

The identification section 64 calculates the size of the read credit card based on the inputted image. With reference to the information media management information, the identification section 64 identifies the type of the information medium corresponding to this size (S4). Thereby, the information medium is identified as the credit card.

When it is determined that the information medium is the credit card, the area determination section 63 determines the position of the specific area within the credit card based on the information medium management information, assigns the position with respect to the inputted image, and determines the specific area (S5).

The area determination section 63 reads the security level of the unique image from the information medium management information (S6). Here, the control section 7 verifies whether or not the user is the administrator (S11). If the user is not the administrator, the control section 7 performs the operations at S7 to S9 of FIG. 8 to perform the image processing for masking the specific area (S12), and the image forming section 3 prints the image (S10).

When the user is the administrator, the control section 7 determines whether or not there is copy restriction with respect to the specific area, based on the security level of the unique image (S13). If the security level of the unique image is lower than the predetermined level, the control section 7 does not mask this specific area. If the security level of the unique image is equal to or more than the predetermined level, the control section 7 sets a range to which the copy restriction is applied (S14). In other words, the control section 7 sets the specific area to be masked. Then, the control section 7 performs the image processing for masking the set specific area (S15). When there are multiple specific areas, the determination is performed with respect to each specific area. The image forming section 3 prints the image (S10).

Thereby, an image in which the specific area has been masked is printed. Depending on the security level of the unique image, an image in which some specific areas are not masked may be printed. It should be noted that, if the administrator hopes to print the image without masking all specific areas, the security level of the unique image to which the copy restriction is applied may be lowered.

In this way, if the administrator having the authority performs the processing such as the copy with respect to the information medium, it is possible to output an image in which important personal information is hidden, by restricting the output of the image. Therefore, although all confidential information is leaked under normal circumstances if the outputted image is misused, some confidential information becomes invisible even in such a case by masking the specific area, and it is possible to prevent the leakage of the confidential information.

It should be noted that the present invention is not limited to the above described embodiment, and of course, it is possible to add many modifications and alterations to the above described embodiment within the range of the present invention. When the type of the information medium is determined, the user may directly input the size through the operation section, instead of calculating the size from the inputted image. Alternatively, the control section displays a list of the information media on the display section when there has been the instruction for the card shot function. Then, the control section may determine the type of the information medium based on selection of the information medium by the user.

When the size has been calculated from the inputted image, if there are multiple information media of the same size, the control section displays the list of the information media of that size on the display section. When the user selects a desired information medium from this list, the control section determines the type of the specified information medium.

The image inputted from the information medium may be an image in which the information medium has been read in the external apparatus, or an image for the information medium created by the external apparatus, and the image is inputted via the data communication from the external apparatus.

The identification information stored in the IC tag may include the information on the position of the specific area, not only the type of the information medium. When the scanning section scans the position information from the IC tag, the area determination section determines the position at which the specific area exists in the inputted image. Since the position information is also obtained in this way, the processing is accelerated and also it is possible to precisely determines the position of the specific area.

Furthermore, the identification information may include authentication information on an owner of the information medium. Whether or not the owner himself is performing the operation can be verified by contrasting the inputted authentication information with the authentication information read from the IC tag. If the third party is performing the operation, the security level is raised to increase the range to be masked. Thereby, it is possible to prevent the leakage of the personal information due to fraudulent use.

What is claimed is:

1. An image processing apparatus comprising:
an input section for inputting an image having a unique image from an information medium;
an area determination section for determining a specific area in which the unique image exists, based on a type of the information medium; and
a control section for performing image processing for selectively masking the specific area.

2. The image processing apparatus according to claim 1, further comprising:
a reading section for communicating with a storage section provided in the information medium and reading identification information from the storage section,
wherein the area determination section determines the specific area based on the identification information.

3. The image processing apparatus according to claim 2, further comprising:
an identification section for identifying the type of the information medium based on the identification information.

4. The image processing apparatus according to claim 2, wherein:
the storage section in the information medium consists of an IC tag, and the reading section communicates with the IC tag in a noncontact manner and receives the identification information.

5. The image processing apparatus according to claim 2, wherein:
the identification information includes information on a position of the specific area, and the area determination section determines a position at which the specific area exists in the inputted image based on the position information.

6. The image processing apparatus according to claim 1, further comprising:
an identification section for identifying the type of the information medium based on a size of the information medium.

7. The image processing apparatus according to claim 1, wherein:
even if output of the image is permitted without restriction, the control section sets a range of the specific area to be masked and outputs an image in which the set specific area has been masked.

8. The image processing apparatus according to claim 7, wherein:
an administrator has an authority for outputting the image without restriction, and when the administrator instructs output of the image of the information medium, the control section selectively masks the specific area.

9. The image processing apparatus according to claim 1, further comprising:
a display section for displaying the specific area,
wherein the specific area displayed on the display section can be modified, and the control section masks the modified specific area.

10. The image processing apparatus according to claim 1, wherein:
the area determination section determines the specific area to be masked depending on a security level.

11. The image processing apparatus according to claim 10, wherein:
the security level can be modified after the image has been inputted.

12. The image processing apparatus according to claim 10, wherein:
the security level of the unique image is set depending on the type of the information medium, and the area determination section determines the specific area depending on the security level of the unique image.

13. The image processing apparatus according to claim 12, further comprising:
an authentication section for authenticating a user,
wherein when the user is a user other than an administrator, the area determination section determines the specific area based on the security level of the user or the security level of the unique image, whichever is higher.

14. The image processing apparatus according to claim 10, further comprising:
an authentication section for authenticating a user,
wherein the security level is set depending on the user.

15. The image processing apparatus according to claim 14, wherein:
the security level of the unique image is set depending on the type of the information medium, and the area determination section determines the specific area based on the security level of the user or the security level of the unique image, whichever is higher.

16. The image processing apparatus according to claim 1, wherein:
when image processing of masking the specific area is executed, the control section prohibits creation of log information with respect to the processing.

17. The image processing apparatus according to claim 1, wherein:
when image processing of masking the specific area is executed, the control section prohibits storage of the inputted image having the unique image.

18. The image processing apparatus according to claim 1, wherein:
the information medium has an image representing personal information as the unique image on its front side surface, and the input section scans the front side surface of the information medium and inputs the image.

19. The image processing apparatus according to claim 1, wherein:
the information medium has images on its front side surface and its back side surface, the input section scans the both sides of the information medium and inputs the images, and the control section synthesizes the images of the both sides and outputs two images side by side.
